(19) United States
(12) Patent Application Publication
(10) Pub. No.: US 2010/0088656 A1
(43) Pub. Date: Apr. 8, 2010

(54) PROPERTY CHECKING SYSTEM, PROPERTY CHECKING METHOD, AND COMPUTER-READABLE STORAGE MEDIUM

(76) Inventor: Akira MUKAIYAMA, Tokyo (JP)

Correspondence Address: Mr. Jackson Chen, 6535 N. STATE HWY 161, IRVING, TX, 75039, US

(21) Appl. No.: 12/410,614

(22) Filed: Mar. 25, 2009

(30) Foreign Application Priority Data
Mar. 25, 2008 (JP) 2008-078196

(51) Int. Cl. G06F 17/50

(52) U.S. Cl. 716/4; 716/18

(57) ABSTRACT

Checking efficiency of property checking is improved. The operation synthesis tool synthesizes an RTL circuit description from a behavioral level circuit description. In addition, the property generating unit generates a behavioral level property from the behavioral level circuit description. Subsequently, the property converting unit converts the generated behavioral level property into an RTL property. The model checking unit then checks the RTL circuit description by model checking technique using the RTL property.

### INCORPORATION BY REFERENCE

This application is based on Japanese Patent Application No. 2008-078196 filed on Mar. 25, 2008, and including specification, claims, drawings and summary. The disclosure of the above Japanese Patent Application is incorporated herein by reference in its entirety.

### TECHNICAL FIELD

The present invention relates to a property checking system, a property checking method, and a computer-readable storage medium.

### BACKGROUND ART

When designing a logic circuit, the so-called “top-down design” is often employed, in which design is performed in a high level of abstraction and conversion into a concrete circuit is performed using design automation/supporting tools in order to cope with the enormous growth of the circuit scale. Design of logic circuits has often been performed in a level of abstraction called register transfer level (referred to as “RTL” in the following description).

In recent years, because larger scale circuits with multiple functions, as well as shorter development periods, are required from the market, there are more occasions in which design is performed in a behavioral level with a higher level of abstraction than the RTL, and conversion into the RTL is performed using an operation synthesis tool (referred to as “behavioral level design” in the following description) in order to cope with such situations.

In order to cope with growing circuit scale and increasing functions thereof, it is also an important challenge to improve the efficiency of checking. Property checking is known as an effective method to improve checking efficiency. Property checking defines operations expected and prohibited in a logical circuit as properties, and checks whether a logical circuit to be checked is designed so that it does not cause an operation violating the properties. Checking is performed by an approach based on a mathematical technique which is referred to as model checking. Model checking is characteristic in that it can detect property violation with a high probability. Property checking and model checking techniques are described in Unexamined Japanese Patent Application KOKAI Publication No. H10-63537, Unexamined Japanese Patent Application KOKAI Publication No. 2005-196681, Unexamined Japanese Patent Application KOKAI Publication No. 2007-241566 or the like.

Unexamined Japanese Patent Application KOKAI Publication No. H10-63537, Unexamined Japanese Patent Application KOKAI Publication No. 2005-196681, and Unexamined Japanese Patent Application KOKAI Publication No. 2007-241566 are incorporated herein by reference.

Because model checking technique requires state transition information, it cannot handle designs of the behavioral level without a concept of a state and it has to handle an RTL circuit description. However, when performing property checking in a behavioral level design, conversion into the RTL is necessary after defining a property in the behavioral level. The reason for this is because many of the RTL circuit descriptions synthesized by an operation synthesis tool are difficult to be compared with the behavioral level description, and thus it is difficult to define a property to be checked (i.e., design specification) on the RTL circuit description.

### SUMMARY

As described above, although property checking is an effective technology for checking LSI design, it is necessary to define properties in order to use property checking. Although it is necessary to define many properties so that the probability of discovering a bug is increased, in order to improve the checking efficiency using property checking, the task is generally difficult and time-consuming.

It is an exemplary object of the present invention, which is conceived in view of the above circumstances, to provide a property checking system, a property checking method, and a computer-readable storage medium, which enhance the checking efficiency of property checking.

In order to achieve the above-mentioned object, a property checking system according to the first exemplary aspect of the present invention includes: a property converting unit which converts a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and a checking unit which checks the behavioral level property by model-checking the circuit description of a register transfer level using the register transfer level property converted by the property converting unit.

In order to achieve the above-mentioned object, a property checking system according to the second exemplary aspect of the present invention includes: a property converting means which converts a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and a checking means which checks the behavioral level property by model-checking the circuit description of a register transfer level using the register transfer level property converted by the property converting means.

In order to achieve the above-mentioned object, a property checking method according to the third exemplary aspect of the present invention includes: converting a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and checking the behavioral level property by model-checking the circuit description of a register transfer level using the register transfer level property converted in the property converting step.

In order to achieve the above-mentioned object, a computer-readable medium according to the fourth exemplary aspect of the present invention stores a program that causes a computer to execute: a property converting procedure which converts a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and a checking procedure which checks the behavioral level property by model-checking the circuit description of a register transfer level using the register transfer level property converted by the property converting procedure.

According to the property checking system, property checking method, and computer-readable storage medium of the present invention, efficiency of property checking can be improved.

### BRIEF DESCRIPTION OF THE DRAWINGS

These objects and other objects and advantages of the present invention will become more apparent upon reading of the following detailed description and the accompanying drawings in which:

FIG. 1 is a block diagram illustrated an arrangement of a property checking system.

FIG. 2 illustrates the operation of the property generating unit.

FIG. 3 illustrates an exemplary behavioral level circuit description written in C-language.

FIG. 4 illustrates an exemplary behavioral level circuit description written in C-language.

FIG. 5 illustrates an exemplary synthesized RTL circuit description.

FIG. 6 illustrates the operation of the property converting unit.

FIG. 7 illustrates an exemplary register signal for expressing a variable X.

### EXEMPLARY EMBODIMENT

In the following, a property checking system 100 according to an embodiment of the present invention will be described, referring to the drawings.

The property checking system 100 synthesizes a behavioral level circuit description of a semiconductor integrated circuit or the like into the RTL circuit description using an operation synthesizing tool. In addition, the property checking system 100 generates a behavioral level property based on the behavioral level circuit description. Furthermore, the property checking system 100 converts the property of the generated behavioral level into the RTL property, based on the correspondence relationship information extracted from the operation synthesis tool. The property checking system 100 then checks the RTL circuit description by model checking using the RTL property.

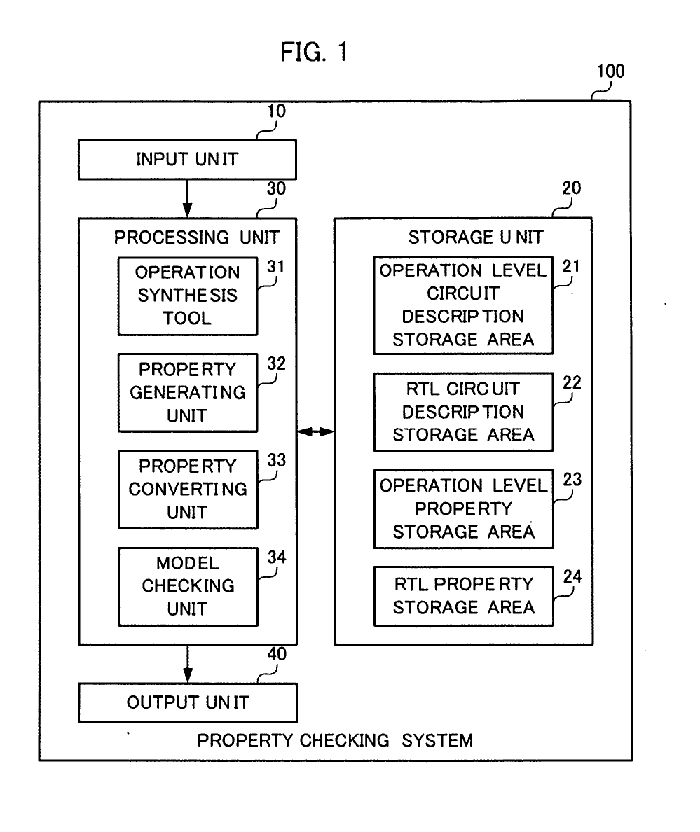

FIG. 1 is a block diagram illustrating the components of the property checking system 100 of the present invention. As shown in FIG. 1, the property checking system 100 comprises an input unit 10, a storage unit 20, a processing unit 30, and an output unit 40.

The input unit 10, comprising a keyboard or the like, supplies a variety of instruction information from a user or a prepared behavioral level circuit description or the like to the processing unit 30.

The storage unit 20, comprising a storage device such as a hard disk for example, stores an operation program executed by the processing unit 30 and also stores various types of data required for realizing the present invention. The storage unit 20 has provided therein a behavioral level circuit description storage area 21, an RTL circuit description storage area 22, a behavioral level property storage area 23, an RTL property description storage area 24 or the like.

The behavioral level circuit description storage area 21 is an area which stores the behavioral level circuit description. The behavioral level circuit description, which is written in a procedure-oriented language such as C-language, describes the operation to be realized by the circuit being designed.

The RTL circuit description storage area 22 is an area which stores the RTL circuit description which is finally generated from the behavioral level description by operation synthesizing processing.

The behavioral level property storage area 23 is an area which stores the behavioral level property to perform property checking.

The RTL property storage area 24 is an area which stores the RTL property to perform property checking.

The processing unit 30, comprising a CPU (Central Processing Unit), a ROM (Read Only Memory), a RAM (Random Access Memory) or the like, controls the operation of the property checking system 100 by executing the operation program stored in the ROM or the storage unit 20, with the RAM serving as a work area.

The processing unit 30 serves as an operation synthesis tool 31, a property generating unit 32, a property converting unit 33, and a model checking unit 34 by executing the operation program stored in the ROM or the storage unit 20.

The operation synthesis tool 31 synthesizes an RTL circuit description from the behavioral level circuit description. The operation synthesis tool 31 generates an RTL circuit description by a scheduling process which determines the timing (cycle) of executing respective processing of the behavioral level circuit description, or a resource binding process which assigns variables and operation of the behavioral level circuit description to hardware resources. For example, as described in “operation synthesizing apparatus and method” of Unexamined Japanese Patent Application KOKAI Publication No. 2006-285333, the RTL circuit description is generated by determining the order of executing the processing or operation described in the behavioral level circuit description and assigning RTL circuit resources such as register signals or processors to each of the processing or operation. Therefore, the operation synthesis tool 31 has correspondence relationship information as to which part of the RTL circuit description corresponds the execution of an arbitrary processing or operation described in the behavioral level description. In addition, the operation synthesis tool 31 stores the generated RTL circuit description in the RTL circuit description storage area 22. Note that the description of Unexamined Japanese Patent Application KOKAI Publication No. 2006-285333 is incorporated herein by reference.

The property generating unit 32 reads the behavioral level circuit description, extracts an attribute necessarily satisfied by the semantics of the description language, and generates a behavioral level property based on the attribute. Details of the operation of the property generating unit 32 will be described below.

The property converting unit 33 converts the behavioral level property into the RTL property based on the correspondence relationship information held by the operation synthesis tool 31. Details of the operation of the property converting unit 33 will be described below.

The model checking unit 34 performs model checking on the RTL circuit description using the RTL property. Through the model checking, the model checking unit 34 can check the circuit to be designed.

The output unit 40, comprising a display unit or the like, displays a screen or the like for various circuit descriptions or property checking under control of the processing unit 30.

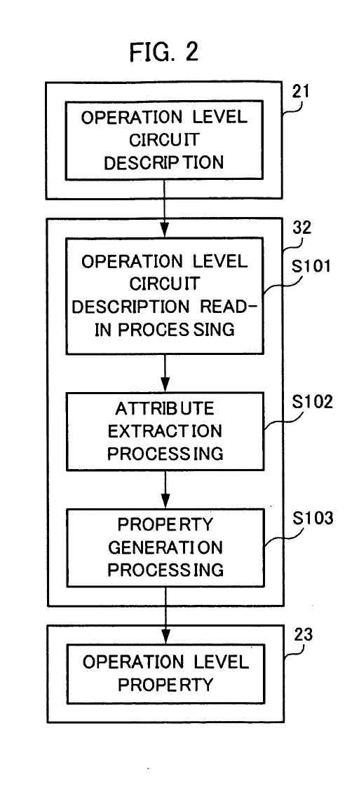

Next, details of the operation of the property generating unit 32 will be described. FIG. 2 illustrates the operation of the property generating unit 32.

The property generating unit 32 first executes a behavioral level circuit description read-in processing (step S101). In the behavioral level circuit description read-in processing, the property generating unit 32 reads the behavioral level circuit description from the behavioral level circuit description storage area 21. The property generating unit 32 can realize the behavioral level circuit description read-in processing by using lexical analysis and syntax analysis as is already realized by C-language compilers or the like.

Next, the property generating unit 32 executes an attribute extraction processing (step S102).

In the attribute extraction processing, the property generating unit 32 extracts the attribute of the circuit description from the behavioral level circuit description which has been read in the behavioral level circuit description read-in processing. The attribute of the behavioral level description is necessarily derived from the semantics of C-language, for example.

The property generating unit 32 then executes a property generation processing (step S103). In the property generation processing, the property generating unit 32 generates the behavioral level property based on the characteristic extracted from the behavioral level circuit description in the attribute extraction processing. Subsequently, the property generating unit 32 stores the behavioral level property generated in the property generation processing into the behavioral level property storage area 23.

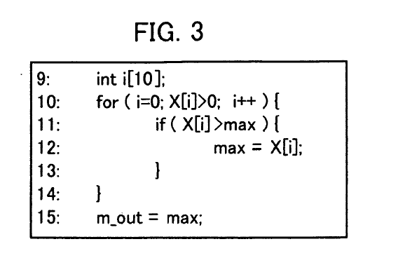

FIG. 3 illustrates a part of the behavioral level circuit description written in C-language. In the following, description will be provided with regard to the operation of the property generating unit 32 to generate the behavioral level property when such a behavioral level circuit description has been read.

A “for” statement which denotes repetition is included in the behavioral level circuit description shown in FIG. 3 (the 10th line). When a repetition statement is described and there is another description following the repetition statement (the 15th line and below), the repetition statement must be eventually finished. The reason for this is because, explicitly describing the operation should mean that execution of the operation is intended, and any subsequently described operation cannot be executed unless the repetition statement is not finished.

In the case of the behavioral level circuit description shown in FIG. 3, repetition statements controlled by the “for” statement are described from the 10th to the 14th lines and another substitution operation is described in the 15th line, respectively. In the attribute extraction processing (step S102) shown in FIG. 2, the property generating unit 32 extracts, from the characteristic of the repetition statement as described above, an attribute that “there exists a condition for terminating the repetition statement starting at the 10th line and ending at the 14th line”.

Next, in the property generation processing (step S103) shown in FIG. 2, the property generating unit 32 converts the above-mentioned attribute to the behavioral level property. Conversion in the property generation processing depends on the definition of the behavioral level description language. In the case of a “for” statement in C-language as shown in FIG. 3, the property generating unit 32 can generate a property by using a continuation conditional expression described in the parenthesis following the “for”. In the case of this example, because X[i]>0 is the continuation conditional expression, the property generating unit 32 can determine the condition for terminating the repetition to be that the continuation conditional expression is false. The property generating unit 32 generates a behavioral level property that “a case such that X[i]>0 is false must necessarily occur at the 10th line”, as the property of the “for” statement.

As another example, let us consider the conditional branching by an “if” statement described in the 11th line of FIG. 3. If there is a condition branch and an operation is described at the branching, the branching condition must be satisfied. The reason for this is because, if the branching condition cannot be satisfied, the operation described in the branching condition will not be executed. In the example shown in FIG. 3, an operation when the condition of the “if” statement of the 11th line is true is described in the 12th line. Therefore, in the attribute extraction processing (step S102) shown in FIG. 2, the property generating unit 32 extracts an attribute that eventually the condition of the “i” statement of the 11th line becomes true.

In the property generation processing (step S103) shown in FIG. 2, the property generating unit 32 generates, from the attribute, a behavioral level property that “there necessarily exists a case that X[i]>max becomes true in the 11th line”, using the conditional expression X[i]>max in the parenthesis following the “if”.

Additionally, as another example, let us consider reference and substitution of the array variable X included in the description of FIG. 3. If the index of an array variable is a variable when referring to or substituting the array variable, the value of the variable must not exceed the size of the array variable. In the description of FIG. 3, X[i] is referred to in the 10th, 11th and the 12th lines. In the variable declaration of the 9th line, on the other hand, the size of the array variable X is declared to be 10. From these information, the property generating unit 32 extracts, in the attribute extraction processing (step S102) shown in FIG. 2, an attribute that “i” is equal to or less than 9 in the 10th, 11th and 12th lines.

In the property generation processing (step S103) shown in FIG. 2, the property generating unit 32 generates, from the attribute, a behavioral level property that “i is necessarily equal to or less than 9 in the 10th line”, “i is necessarily equal to or less than 9 in the 11th line”, and “i is necessarily equal to or less than 9 in the 12th line”.

In the above-mentioned manner, the property generating unit 32 generates a behavioral level property from the behavioral level circuit description. Here, the behavioral level property is described by PSL (Property Specification Language) which is standardized in IEEE, for example. PSL can be expanded to the notation of the intended behavioral level description language and used.

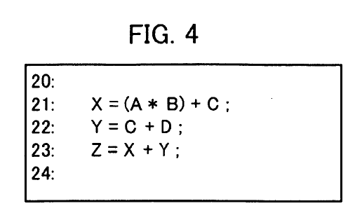

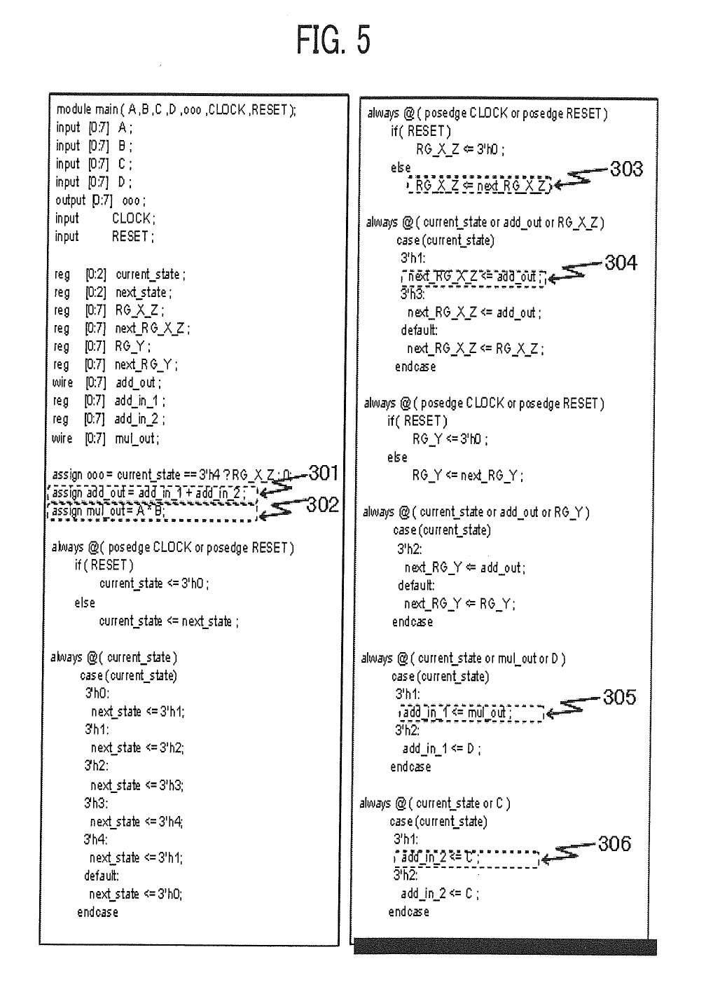

Subsequently, details of the operation of the property converting unit 33 will be described. Here, for simplicity of explaining the operation of the property converting unit 33, explanation will be given using an example which is different from the circuit description shown in FIG. 3. For example, checking the behavioral level property that “variable X is always larger than 2” will be described in a case where an RTL circuit description shown in FIG. 5 is synthesized from a behavioral level circuit description written in C-language as shown in FIG. 4.

Here, when C-language is used as the behavioral level description language, a property that “variable X is always larger than 2” can be expressed as shown below using PSL which is extended to the notation of C-language.

assert always (X>2)

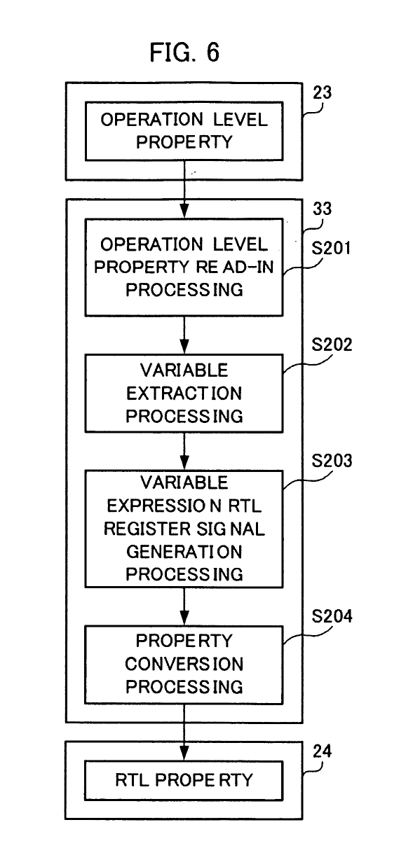

FIG. 6 illustrates the operation of the property converting unit 33. The property converting unit 33 first executes a behavioral level property read-in processing (step S201). In the behavioral level property read-in processing, the property converting unit 33 reads the behavioral level property which is formally expressed as mentioned above into the computer by a mechanical processing using lexical analysis and syntax analysis. In the above example, reading is performed by decomposing into “assert” which unit “expression of being logically true”, “always” which unit “always”, “X” which is interpreted as a variable, “>” which is a symbol expressing the magnitude relation, and “2” which is interpreted as a constant to determine the meaning of the entire property.

Next, the property converting unit 33 executes a variable extraction processing (step S202). In the variable extraction processing, the property converting unit 33 extracts a variable included in the read-in behavioral level property and determines how the variable is defined in the behavioral level circuit description. In this example, how the variable X is defined in the behavioral level circuit description is determined because the variable X is included in the behavioral level property. The behavioral level circuit description can be read into the computer by mechanical processing through lexical analysis and syntax analysis, using operation synthesis tool 31. Of the information which has been syntax-analyzed and stored in the computer, it is easy to specify the part in which the variable X is defined. For example, it is determined that the value of the variable X is determined in the 21st line for the behavioral level description shown in FIG. 4.

Next, the property converting unit 33 generates an RTL register signal expressing the variable X in the behavioral level circuit description by executing a variable expression RTL register signal generation processing (step S203). In the variable expression RTL register signal generation processing, the property converting unit 33 first determines, by acquiring correspondence relationship information from the operation synthesis tool 31, which part of the RTL circuit description in FIG. 5 generated by operation synthesis the behavioral level circuit description of the 21st line of FIG. 4 corresponds to. A concrete example of correspondence relationship information acquired from the operation synthesis tool 31 will be described below.

As stated above, the operation synthesis tool 31 has correspondence relationship information indicating which part of the RTL circuit description the execution of an arbitrary processing or operation described in the behavioral level description corresponds to. For example, the description of FIG. 4 “X=(A*B)+C; of the 21st line” is composed of three operations or processing: (1) multiplication of A and B, (2) addition of the result and C, and (3) substitution of the result to the variable X. Each of these operations and processing corresponds to (1) the operation executed in 302, (2) the operation executed in 301 using add_in_{—}1 substituted in 305 and add_in_{—}2 substituted in 306, and (3) the substitution to register signal RG_X_Z executed in 303 using next_RG_X_Z substituted in 304, in the RTL circuit description shown in FIG. 5.

By acquiring the above-mentioned correspondence relationship information from the operation synthesis tool 31, the property converting unit 33 can determine that the value of the variable X determined in the behavioral level circuit description of the 21st line of FIG. 4 is substituted in 303 under the condition that 301, 302, 303, 304, 305 and 306 are executed in the RTL circuit description.

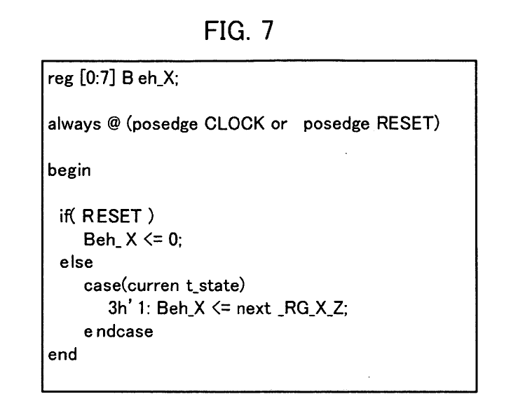

Next, the property converting unit 33 newly generates, in the RTL circuit description, a register signal to express the value of the variable X of the behavioral level circuit description based on the acquired correspondence relationship information. The property converting unit 33 generates, for example, a register signal Beh_X, which is defined as shown in FIG. 7 applying the correspondence relationship information acquired from the operation synthesis tool 31. This stands for substituting into Beh_X the value to be substituted in RG_X_Z under the condition that 301, 302, 303, 304, 305 and 306 are all executed. Here, in this example, although the value of the variable X determined in the behavioral level circuit description is supposed to correspond to only a single substitution in the RTL circuit description, substitution into Beh_X may be generated for respective substitutions if the value corresponds to a plurality of substitutions in the RTL circuit description.

Finally, the property converting unit 33 executes an RTL property conversion processing (step S204). In the RTL property conversion processing, the property converting unit 33 converts the behavioral level property

assert always (X>2)

into an RTL property

assert always (Beh_X>2)

by using the register signal Beh_X generated in the variable expression RTL register signal generation processing.

In this manner, the property converting unit 33 generates an RTL property from the behavioral level property.

As explained above, the processing unit 30 of the property checking system 100 according to the embodiment, the property generating unit 32 generates a behavioral level property from the behavioral level circuit description, and the property converting unit 33 converts the behavioral level property to an RTL property. The model checking unit 34 then checks the behavioral level property by applying the RTL model checking technology, which is an existing technology, to the RTL property and the RTL circuit description, and checking the truth or false of the property. By arranging that such a process is automatically executed by the processing unit 30, it becomes possible to automatically and efficiently execute checking of the behavioral level circuit description.

Note that the above-mentioned embodiment is intended to make it easier to understand the principle of the present invention, thus the scope of the present invention is not limited to the embodiments described above, and other embodiments, which are appropriately substituted arrangements of the following embodiments by a person skilled in the art, are also included in the scope of the present invention.

For example, in the above-mentioned embodiment, although the property converting unit 33 converts the behavioral level property to the RTL property by generating a register signal expressing a variable of the behavioral level from the correspondence relationship information of the behavioral level circuit description and the RTL circuit description, this is not limited and any method will suffice provided that the conversion is based on the correspondence relationship information of the behavioral level circuit description and the RTL circuit description.

Additionally, in the above-mentioned embodiment, although a behavioral level circuit description written in C-language as shown in FIG. 3 is presented as a concrete example of the behavioral level circuit description, this is not limited and the present invention can also be applied to the behavioral level circuit description using other procedural programming languages or HDL (Hardware Description Language) or the like.

In addition, the property checking system 100 of the present invention is not limited to a dedicated hardware and can be realized with an ordinary computer. Specifically, an explanation that a program is preliminarily stored in the ROM or the like has been provided. However, it may be arranged such that the program that executes the above-mentioned processing operation is stored in a computer readable recording, medium such as a flexible disk, a CD-ROM (Compact Disk Read-Only Memory), a DVD (Digital Versatile Disk), an MO (Magneto-Optical disk) and distributed, and cause the computer to execute the above-mentioned operation by installing the program in the computer.

In addition, it may be arranged such that the program is stored in a disc unit etc. included in a server device on a communication network such as Internet, and the program, superimposed on a carrier wave, is downloaded to a computer, for example. Furthermore, the above-mentioned processing can also be achieved by activating and executing the program while transferring it over a communication network.

In addition, when the above-mentioned function is realized by the OS (Operating System) sharing the task or by cooperation of the OS and the application, only the part other than the OS may be stored in the medium and distributed, or, may be downloaded to a computer.

Various embodiments and changes may be made thereonto without departing from the broad spirit and scope of the invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

What is claimed is:

1. A property checking system comprising:
a property converting unit which converts a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and
a checking unit which checks the behavioral level property by model-checking the circuit description of a register transfer level using the register transfer level property converted by the property converting unit.

2. The property checking system according to claim 1, wherein the property converting unit further comprises:
a variable extracting unit which extracts a variable from the behavioral level property; and
a register signal generating unit which generates, from the variable extracted by the variable extracting unit, a register signal of a register transfer level based on correspondence relationship information acquired from an operation synthesis tool which converts the behavioral level circuit description to a circuit description of a register transfer level,
and converts the behavioral level property to the register transfer level property using the register signal generated by the register signal generating unit.

3. The property checking system according to claim 1 further comprising:
an attribute extracting unit which extracts an attribute necessarily derived from the characteristic of the behavioral level circuit description, and
a property generating unit which generates a behavioral level property based on the property extracted by the attribute extracting unit.

4. A property checking system comprising:
a property converting means which converts a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and
a checking means which checks the behavioral level property by model-checking the circuit description of a register transfer level using the register transfer level property converted by the property converting means.

5. A property checking method comprising the steps of:
converting a behavioral level property for the behavioral level circuit description to a register transfer level property for the circuit description of the register transfer level based on the correspondence relationship information provided from an operation synthesis tool which converts the behavioral level circuit description to a circuit description of the register transfer level; and
checking the behavioral level property by model-checking the circuit description of a register transfer level using the register transfer level property converted in the property converting step.

6. A computer-readable medium which stores a program that causes a computer to execute:
a property converting procedure which converts a behavioral level property for the behavioral level circuit description to a register transfer level property for the circuit description of the register transfer level, based on the correspondence relationship information provided from an operation synthesis tool which converts the behavioral level circuit description to a circuit description of the register transfer level; and
a checking procedure which checks the behavioral level property by model-checking the circuit description of a register transfer level using the register transfer level property converted by the property converting procedure.
